(19) United States
(12) Patent Application Publication
(10) Pub. No.: US 2010/0273068 A1
(43) Pub. Date: Oct. 28, 2010

(54) FUEL CELL SYSTEM INCLUDING A FUEL FILTER MEMBER WITH A FILTER PROPERTY INDICATOR

(75) Inventors: Aaron T. Crumm, Ann Arbor, MI (US); John Muczynski, Ypsilanti, MI (US); Mike Gorski, Ann Arbor, MI (US); Jason Krajcovic, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/428,112

(22) Filed: Apr. 22, 2009

(51) Int. Cl. H01M 8/00; H01M 8/18; G06F 19/00

(52) U.S. Cl. 429/410; 429/429; 429/462; 702/22

(57) ABSTRACT

A fuel cell system includes a fuel tank, a replaceable fuel filter, a fuel cell stack, and a control system. The fuel tank includes raw fuel stored therein. The replaceable fuel filter member includes a filter property indicator and is configured to receive raw fuel from the fuel tank and to refine the raw fuel to a refined fuel. The fuel cell stack is configured to receive refined fuel from the fuel filter and to utilize the refine fuel to generate electricity and a control system configured to access the filter property indicator of the fuel filter member.

### GOVERNMENT INTERESTS

This invention was made with government support under contract number W909MY-08-C-0025, awarded by the Department of Defense. The government has certain rights in this invention.

### FIELD OF THE INVENTION

This application is related to fuel filters for solid oxide fuel cell systems.

### BACKGROUND

The statements in this section merely provide background information related to the present disclosure and may not constitute prior art.

Fuel flexible fuel cells can be adapted to operate utilizing various types of fuel. An exemplary fuel flexible fuel cell is a solid oxide fuel cell, which can be configured to generate electricity utilizing various different types of hydrocarbon and oxygenated hydrocarbon fuels and fuel blends. Certain fuel flexible fuel cells are especially desirable in that they utilize fuels that are low-cost and widely available in the marketplace such as propane and butane.

Commercially available propane and butane fuels typically contain sulfur containing molecules such as, ethyl mercaptan, an odor-producing additive that allows humans to detect releases of the fuel into the atmosphere. Ethyl mercaptan is a sulfur-containing organic molecule that can degrade the operational performance of solid oxide fuel cell catalysts. Further, commercially available fuel can contain hydrogen sulfide, organic sulfides, or other sulfur containing species either naturally occurring in the raw fuel or inserted during processing, which can degrade operational performance of the fuel cell. In addition to sulfur containing molecules, commercially available fuels can contain other molecules and particulates that can degrade operational performance of the fuel cell. Therefore, it is desirable to prevent ethyl mercaptan along with other potential fuel cell poisoning molecules from interacting with the fuel cell.

Fuel can be routed through a fuel filter prior to being routed to the fuel cell to remove potential poisons, contaminants, non-fuel molecules, debris, or other undesirable components contained within the fuel tank. However, if the fuel filter does not have sufficient poison removal properties, poisons can pass through the fuel filter and degrade the operational performance of the fuel cells. For example, a fuel filter may not efficiently remove poisons if the fuel filter is incompatible with the specific fuel utilized or if the filter is utilized beyond its operational lifetime. Typically, the operational lifetime of the fuel filter is much shorter than the operational lifetime of the fuel cell and therefore, the fuel filter must be replaced several times throughout the operational lifetime of the fuel cell.

Further, it is desirable to allow a fuel cell system to utilize several types of fuel filters including fuel filters that vary in design by, for example, volume and filtering media type. The fuel filter can be optimized for specific fuels, fuel cell operating modes and fuel cell operating environments. However, if a fuel cell system control scheme is optimized for a specific fuel filter design, utilizing alternate fuel filter design may resulting in degraded operation and possible failure modes for the fuel cell. Therefore, fuel cell systems having improved fuel filters are needed.

### BRIEF DESCRIPTION OF THE DRAWINGS

FIG. 1 depicts a prospective view of a fuel cell system in accordance with an exemplary embodiment of the present disclosure;

FIG. 2 depicts a cross-sectional view of the fuel cell system of FIG. 1;

FIG. 3A depicts a prospective view of a fuel filter member of the fuel cell system of FIG. 1;

FIG. 3B depicts a cross-sectional view of the fuel filter member of FIG. 3A;

FIG. 4 depicts a prospective view of a fuel filter member in accordance with another exemplary embodiment of the present disclosure;

FIG. 5 depicts a schematic fluid and signal flow diagram of the fuel cell system of FIG. 1;

FIG. 6 depicts a schematic signal flow diagram of the fuel cell system of FIG. 1; and

FIG. 7 depicts a schematic signal flow diagram of a fuel cell system in accordance with another exemplary embodiment of the present disclosure.

It should be understood that the appended drawings are not necessarily to scale, presenting a somewhat simplified representation of various preferred features illustrative of the basic principles of the invention. The specific design features of the fuel cell will be determined in part by the particular intended application and use environment. Certain features of the illustrated embodiments have been enlarged or distorted relative to others for visualization and understanding. In particular, thin features may be thickened for clarity of illustration. All references to direction and position, unless otherwise indicated, refer to the orientation of the solid state electrochemical device illustrated in the drawings.

### SUMMARY

In accordance with an exemplary embodiment, a fuel cell system includes a fuel tank, a replaceable fuel filter member, a fuel cell stack, and a control system. The fuel tank includes raw fuel stored therein. The replaceable fuel filter member includes a filter property indicator and is configured to receive raw fuel from the fuel tank and to refine the raw fuel to a refined fuel. The fuel cell stack is configured to receive refined fuel from the fuel filter and to utilize the refined fuel to generate electricity. The fuel cell system further includes a control system configured to access the filter property indicator of the fuel filter member.

In accordance with another exemplary embodiment, a method for controlling a fuel cell system includes accessing the fuel filter information of the data storage member; and selecting an operating mode of the fuel cell system based on the fuel filter information.

### DETAILED DESCRIPTION OF THE EMBODIMENTS

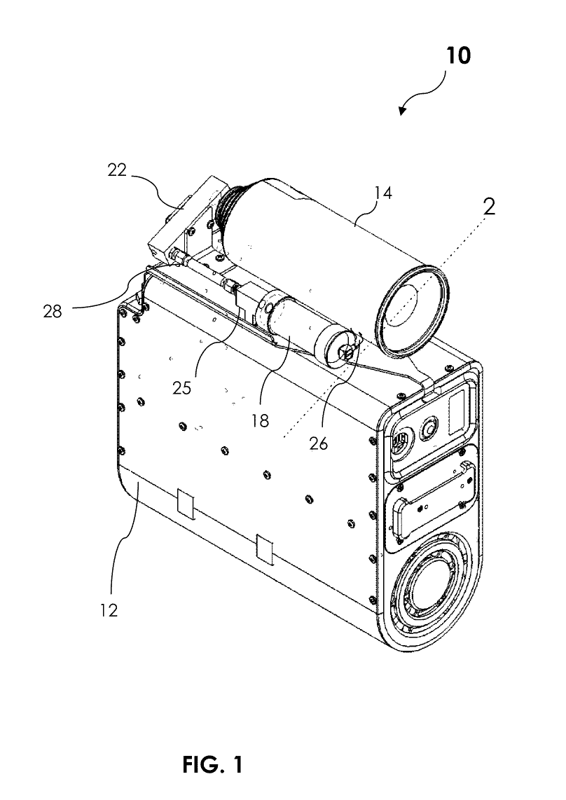

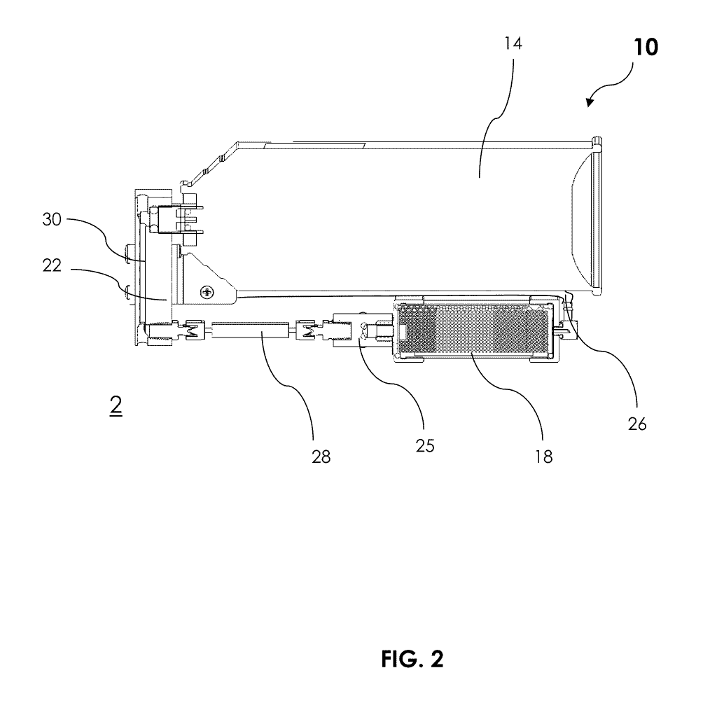

FIGS. 1 and 2 show a fuel cell system 10. The fuel cell system 10 includes a fuel reservoir 14, a mounting assembly 22, a filter connection member 25, a fuel filter member 18, a fuel feed tube 26 and a housing 12.

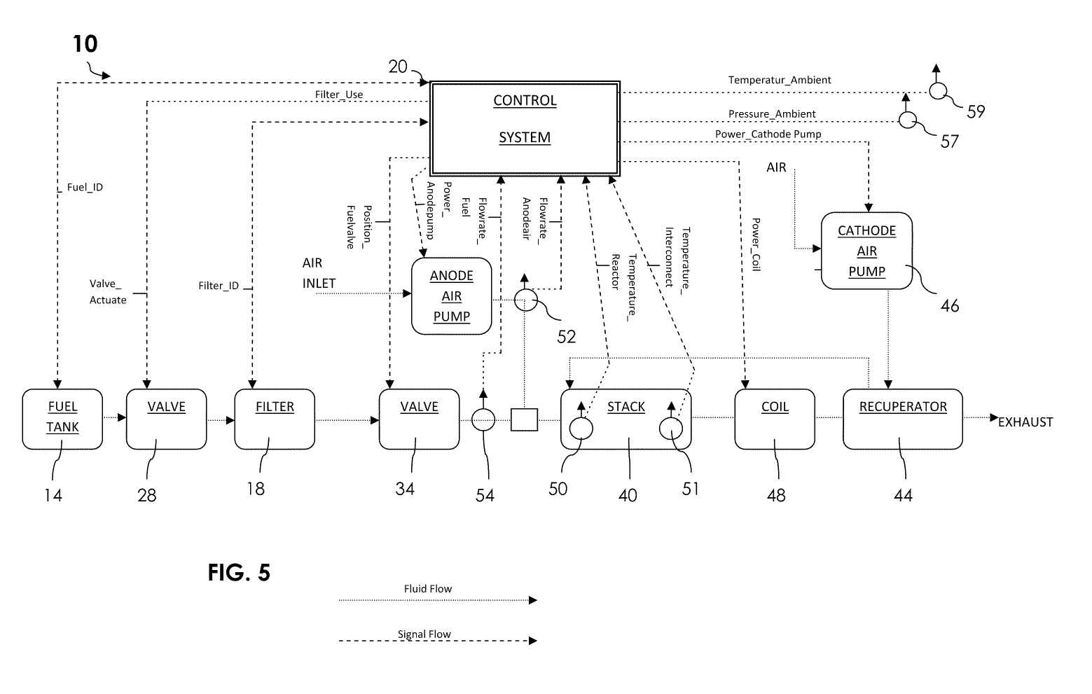

The fuel reservoir 14 contains a raw fuel for use by the fuel cell stack 40. Exemplary fuels include a wide range of hydrocarbon fuels. The terms “raw fuel” as used herein refer to fuel in a state before being processed within a fuel filter. The raw fuel can contain one or more components that can be partially or completely removed prior to routing the fuel to a fuel cell stack 40 (FIG. 5) of the fuel cell system 10. In various embodiments of the present disclosure the amount of undesirable components removed by the fuel filter member can vary based on the specific type of raw fuel utilized. For example, in one embodiment, the filter can remove between one part per million and one hundred parts per million undesirable components from the raw fuel.

Exemplary undesirable components contained within the raw fuel can include sulfur containing molecules and particulates. The raw fuel also can include mixtures comprising combinations of various component fuel molecules, examples of which include gasoline blends, liquefied natural gas, JP-8 fuel and diesel fuel. Further, in various embodiments, the fuel cell system can utilize fuels having various grades, hydrocarbon ratings, refinement levels and purity levels. Thus, the exact fuel composition is to be understood to be not limiting on the present disclosure. Exemplary fuels comprise one or more other types of fuels, such as alkane fuels, for example, methane, ethane, propane, butane, pentane, hexane, heptane, octane, nonane, decane, along with hydrocarbon molecules with greater number of carbon atoms such as cetane, and the like, and can include non-linear alkane isomers. Further, other types of hydrocarbon fuel, such as partially and fully saturated hydrocarbons, and oxygenated hydrocarbons, such as alcohols and glycols, can be utilized as raw fuel. In one embodiment, the raw fuel comprises an ethyl mercaptan additive, for example, propane fuel with the ethyl mercaptan additive.

The mounting assembly 22 includes an internal passageway 30 for routing fuel from the fuel reservoir 14 to the valve 28. The valve 28 is configured to control whether raw fuel from the fuel reservoir 14 is routed to the fuel filter member 18 and to control the rate of raw fuel being supplied from the fuel reservoir 14 to the fuel filter member 18. The valve 28 is configured to receive a signal (‘VALVE_ACTUATE’) (FIG. 5) from the control system 20 to control valve actuation and thus control a raw fuel flow rate through the valve 28.

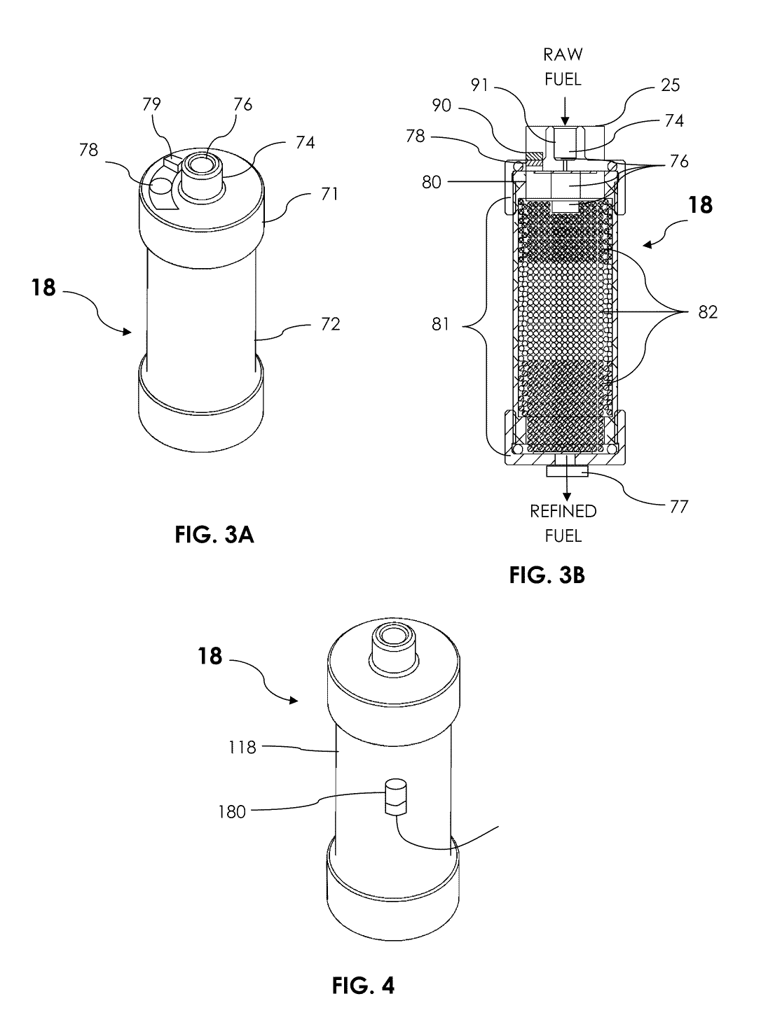

Referring to FIGS. 3A and 3B, the fuel filter member 18 includes a fuel inlet 76, a fuel outlet 77, an interface portion 71 and a filter portion 72. The interface portion 71 includes a fuel adapter fitting 76 disposed on an outer circumference of the fuel inlet 74 for providing a gas-tight seal between the fuel filter member 18 and an internal passageway 91 of the connection member 25 such that the filter assembly 18 can receive raw fuel from the connection member 25.

The interface portion 71 further includes a filter data module 80 configured to send and receive data through a filter data port 78 positioned proximate an orientation member 79. The orientation member 79 provides a desired orientation of the fuel filter member 18 within the fuel cell system 10 such that the filter data module 80 can communicate with a interface port 90 of the filter connection member 25 and thereby interface with the control system 20. In the exemplary embodiment depicted in FIG. 3A, the orientation member comprises a stop member which abuts against a complementary member (not shown) of the filter connection member 25. In alternative embodiments, other orientation members can be utilized to orient the fuel filter member relative to the filter connection member 25. Exemplary alternative orientation members include protruding members, recessed portions such as grooves, interlocking members and the like.

In an exemplary embodiment, the fuel filter data module 80 utilizes single-wire communication to communicate with the control system 20 by sending information to and receiving information from a communications bus of the control system 20 via the interface port 90. The fuel filter data module 80 sends information to the communications bus during a first time period of a loop cycle and receives information from the communications bus during a second time period of each loop cycle. The specific communications type utilized can depend on, for example, a desired performance level, desired control speed, desired amounts of data transferred, and desired reliability levels. In one embodiment, the control system 20 utilizes a 1-Wire device from Maxim Integrated Products, Inc. The interconnected circuits or devices employing other interface protocols, such as RS-232, RS-422, RS-423, RS-485, J1708, SPI, Microwire, and I2C can be utilized in other exemplary embodiments.

The filter data module 80 includes a memory device that can store information including preconfigured information and information received from the communications bus and stored for later retrieval.

In an exemplary embodiment, the useful operating life of the fuel filter member 18 is much lower than the useful operating life of the fuel cell stack 40. Therefore, providing a removable and replaceable fuel filter member 18 having a fuel property indicator, and in particular a fuel life indicator, allows the fuel cell system 10 to track the useful life of the filter assembly 18 and to utilize multiple filters throughout the useful operating lifetime of the fuel cell stack 40. Further, in one embodiment, the fuel filter member 18 can be used for a portion of the fuel filter member's useful life in a first fuel cell system and then subsequently transferred to a second fuel cell system, where the fuel filter member can be utilized for a second portion of the fuel filter member's useful life, wherein the second fuel cell system is able to read the remaining useful life from the filter data module 80.

The fuel filter member 18 is utilized to process raw fuel to a refined fuel and routes the refined fuel to the fuel feed tube 26, wherein the refined fuel is routed to the fuel cell stack 40 inside the housing 12. The fuel filter member 18 includes filtering media 82 disposed within the inner chamber 81 such that the fuel can enter the fuel inlet 74, react with the filter media to refine the fuel, and subsequently exit the fuel filter member through the fuel outlet 77. The term “refined fuel” as used herein refers to fuel in a state after being processed within the fuel filter member 18. The filtering media 82 can comprise one or more filtering or absorbent materials. The filtering media 82 can be in one of many exemplary forms including filter paper, filter paper with reactive material disposed thereon, a packed bed, beads, foams, fibers, and like forms. Sulfur containing molecules such as ethyl mercaptan additive and other undesirable components can be filtered or absorbed by the filtering media. Exemplary absorbent components can include silica, for example, silica in the form of silica gel, alumina, and activated copper oxide. The filtering member 82 can further include sodium oxide, zinc oxide, silver oxide, calcium oxide, iron (III) oxide, and magnesium oxide, and can include mixtures with water or aqueous forms of the foregoing materials. Although exemplary material is described for an exemplary fuel filter member 18, one benefit of the fuel cell system 10 is that it can utilize different fuel filters for operation with different types of fuel and therefore, is adaptable to fuel filter member designs that vary greatly from the exemplary fuel filter member 18.

Referring to FIG. 4, in accordance with another exemplary embodiment, a fuel filter member 118 includes a data port 180 mounted on an outer wall of the fuel filter member 118 and plugged into the communications bus of the control system 20. Further, it is to be understood that in other exemplary embodiments, the filter data module 80 can be located various on other locations and can communicate with the control system of the fuel stack 40 utilizing various other communications methods including multiple-wire communications methods, optical communications methods and wireless communications methods.

Referring to FIG. 5 the fuel cell system 10 includes a control system (‘CONTROL SYSTEM’) 20, a fuel cell stack 40 (‘STACK’) disposed within an insulative body (not shown), an anode air pump 33 (‘ANODE AIR PUMP’), a cathode air pump 46 (‘CATHODE AIR PUMP’), a fuel valve 34 (VALVE), and a recuperator 44 (‘RECUPERATOR’). The insulative body comprises thermally insulative material capable of withstanding the operating temperatures of the fuel cell stack 40, that is, temperature of up to 1000 degrees Celsius. The recuperator 44 comprises a heat exchange manifold for transferring heat from fuel cell exhaust gas to ambient air inputted to the fuel cell stack 40.

The fuel cell system 10 further includes a plurality of sensors providing signals to the control system 20. Signals monitored by the control system 20 include an ambient pressure (‘PRESSURE_AMBIENT’) from an ambient pressure sensor 57, an ambient temperature (‘TEMPERATURE_AMBIENT’) from an ambient temperature sensor 59, actual fuel flow rate (‘FLOWRATE_FUEL’) from a fuel flow rate sensor 54, an actual anode air flow rate (‘FLOWRATE_ANODEAIR’) from anode air flow rate sensor 52, a reactor temperature (‘TEMPERATURE_REACTOR’) from a temperature sensor 50 proximate internal reformation reactors disposed within fuel cell tubes of the fuel cell stack 40, and an interconnect temperature (‘TEMPERATURE_INTERCONNECT’) from a temperature sensor 52 disposed proximate interconnect members at the exhaust ends of fuel cell tubes of the fuel cell stack 40. The control system 20 is configured to provide signals to send commands to component actuators of the fuel cell stack 40. The signals commanded by the control system 20 include a valve position (‘POSITION_FUELVALVE’), an anode air pump power level (‘POWER_ANODEPUMP’), a coil power (TOWER COIL), and a cathode air pump power level (‘POWER_CATHODEPUMP’).

The cathode air pump 46 pumps ambient air through the recuperator 44 and into the fuel cell stack 40 and an exhaust fan (not shown) pulls exhaust gases (‘EXHAUST’) away from the fuel cell stack 40. The fuel valve 34 controls fuel flow from the fuel reservoir 14 to the fuel cell stack 40 and the anode air pump 52 pumps ambient air to the fuel cell stack 40, wherein the ambient air and fuel are combined. The coil 48 comprises a resistant heating coil that can heat fuel and air that pass through the fuel cell stack 40 to combust the air and fuel.

The fuel cell stack 40 comprises a plurality of solid oxide fuel cell tubes, along with various other components, for example, air and fuel delivery manifolds, current collectors, interconnects, and like components, for routing fluid and electrical energy to and from the component cells within the fuel cell stack 40. The solid oxide fuel cell tubes electrochemically transform the fuel gas into electricity and exhaust gases. The actual number of solid oxide fuel cell tubes depends in part on size and power producing capability of each tube and the desired power output of the SOFC. Each solid oxide fuel cell includes an internal reformer disposed therein. The internal reformer can refine fuel such that the reformed fuel can be reacted at an anode of the fuel cell tube.

The control system 20 comprises a microprocessor configured to execute a set of control algorithms, comprising resident program instructions and calibrations stored in storage mediums to provide the respective functions. The control system 20 can monitor input signals from sensors disposed throughout the fuel cell system 10 and can execute algorithms in response to the monitored input signals to execute commands to control power, reactant flows, and component operations of the fuel cell system 10.

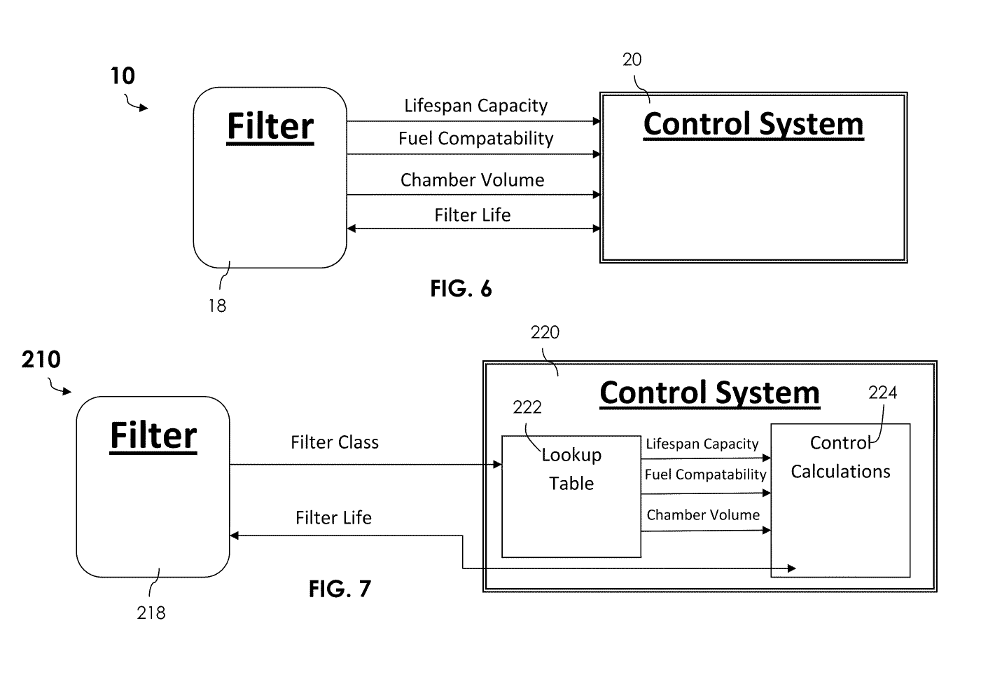

Referring to FIG. 5 a fluid and signal flow diagram of the fuel cell system 10 is shown. A filter identification signal (‘FILTER_ID’) is communicated between the filter data module 80 of the fuel filter member 18 and the control system 20. The filter identification signal comprises filter assembly information such as components shown in FIG. 6 including a lifespan capacity level (‘LIFESPAN CAPACITY’), a fuel compatibility identifier (‘FUEL COMPATIBILITY)’, a chamber volume level (‘CHAMBER VOLUME’), a remaining filter life level (‘FILTER LIFE’) and a fuel cell system status (‘SYSTEM STATUS’).

The lifespan capacity level represents an overall amount of undesirable components that the fuel filter member 18 can eliminate prior to the end of the fuel filter member's useful operating life. The exemplary lifespan capacity level is a fixed value stored (i.e., factory configured value) in the data storage media of the filter data module 80. In one embodiment, the lifespan capacity level can include multiple values, wherein each value contains a lifespan capacity level for a type of fuel utilized within the fuel cell system 10. The lifespan capacity level can be received by the control system 20. The lifespan capacity level can be utilized by the control system in various algorithms and calculations as will be described in further detail below.

The fuel compatibility identifier identifies the type of raw fuel that the fuel filter member is configured to refine to refined fuel. In an exemplary embodiment, the control system 20 compares the fuel compatibility identifier with a raw fuel type identifier to determine compatibility between the fuel filter and the raw fuel. The raw fuel identifier (FUEL_ID) can be provided by a microprocessor of the fuel reservoir 14 communicating with the communications bus of the control system 20. If the control system 20 determines that the fuel filter and the raw fuel are not compatible, the control system 20 can send a signal to notify a user of the fuel cell system 10 of fuel and filter incompatibility and can restrict or not allow operation of the fuel cell system 10.

The chamber volume level indicates the amount of fluid for example ambient area that can occupy the chamber 82 during operation of the filter assembly 18. The fuel filter 18 can regulate fluid flow by maintaining a pressure level between a pressure level of the fuel reservoir and a pressure level downstream the valve 34, thereby allowing consistent control of fuel flow through the valve 34. Therefore, the chamber volume is utilized by the control system 20 to determine values within feedback control algorithms and values for controlling the valve 34 to provide selected levels of fuel to the fuel cell stack 40. Further, chamber volume along with ambient temperature level can be utilized by the control system in determining value for controlling the valve 34.

The remaining filter life level indicates a remaining filtering capacity of the fuel filter member 18. During each loop cycle, the control system 20 receives the remaining filtering capacity of the fuel filter member 18, determines a new remaining filtering capacity of the fuel filter member 18 and the new remaining filtering capacity is stored in the storage media of the filter data module 80.

The system status can be written to the filter assembly if the fuel cell system enters an internally or externally commanded operational state. Exemplary operating states include a low fuel operating state, a no fuel operating state, an automatic shutdown operating state, a lower battery power operating state, a system fault operating state, a system idol operating state, and a standard operating state.

Remaining filter life level at loop cycle time N (hereafter, filter life level N) is continually received by control system 20 and the control system 20 utilizes the filter life level N to determine a new filter life level for a next loop cycle time (N+1) according to equation (1), below:

Remaining Filter Life (N)−Filter Usage (N)=Remaining Filter Life (N+1) (1)

Prior to Utilizing the Filter 18 to Refine Fuel for the Fuel Cell System 10, the remaining filter life value can be set based on the lifespan capacity level. In one embodiment, the value for filter usage (N) is a fixed value such that the control system 20 counts down remaining filter life in fixed increments during each loop cycle. In one embodiment, the value for filter usage (N) is calculated based on the fuel flow rate (‘FLOW RATE_FUEL’) detected by the fuel flow rate sensor 54. In one embodiment, the filter usage value can be determined based on the type of raw fuel or based on both the type of raw fuel and the filtering capability of the fuel filter member 18, wherein the filtering capability of the fuel filter member 18 is selected based on the type of raw fuel. In alternative embodiments, other control conditions within the fuel cell system 10 such as temperature levels and other fluid flow rates within the fuel cell system are utilized. In an exemplary embodiment, the control system 20 is continually comparing the remaining filter life to a first threshold filter life and the control system 20 is configured to command system shutdown (by discontinuing fueling to the fuel cell stack 40) when the remaining filter life falls below the first threshold filter life. In an exemplary embodiment, the control system 20 is continually comparing the remaining filter life to a second threshold filter life and the control system 20 is configured to send a warning signal to a fuel cell user when the remaining filter life falls below the second threshold filter life. In one embodiment, the fuel cell system 10 includes a user override function so that the user can continue operating the fuel cell system 10 when the fuel cell system 10 is actively sending the warning signal.

Referring to FIG. 7, in an alternative embodiment, the data module of a fuel filter (‘FILTER’) 218 sends filter classification information (‘FILTER CLASS’) to the control system 220 and the control system 220 utilizes a lookup table 222 to determine filter information including the lifespan capacity level (‘LIFESPAN CAPACITY’), the fuel compatibility identifier (‘FUEL COMPATIBILITY’), and the chamber volume level (‘CHAMBER VOLUME’), which are utilized by control calculator 224 of the control system 220. The control calculator 224 is utilized to control actuators of the fuel cell system 20 and can be utilized to update the filter life level at each loop cycle.

In other embodiments, optimal system control parameter of fuel cell systems can vary based on the fuel filter member to the fuel cell system. For example, a preferred air-to-fuel ratio provided to a fuel reformer of the fuel cell system can vary based on the filter identification signal. For example, the maximum fuel flow rate allowed into a given filter given a certain ambient temperature and other environmental conditions. For example, information from the combination of filter type and fuel type (not shown item) could utilized to determine operating set points, such as fuel cell stoichiometry, fuel reforming conditions, target operating temperatures, fuel utilization limitations, The information transmitted to the fuel cell system from the filter assembly can be used to notify the operator of additional operational constraints for the fuel cell system, for example, the ability to invert the fuel filter or fuel tank during operation.

Further, other embodiments can utilize other modified control schemes based on the filter identification signal.

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A fuel cell system comprising:
a fuel reservoir comprising a raw fuel stored therein,
a replaceable fuel filter member configured to receive raw fuel from the fuel reservoir and to refine the raw fuel to a refined fuel, said replaceable filter comprising a data storage device configured to store filter property information thereon,
a fuel cell stack configured to receive refined fuel from the fuel filter and to utilize the refined fuel to generate electricity, and
a control system configured to access the data storage device of the fuel filter member.

2. The fuel cell system of claim 1, wherein the data storage device is configured to store remaining filter life information thereon.

3. The fuel cell system of claim 2, wherein the data storage device is configured to determine the remaining filter life based on fuel cell operating time.

4. The fuel cell system of claim 2, wherein the data storage device is configured to determine the remaining filter life based on a fuel flow rate through the fuel filter member.

5. The fuel cell system of claim 2, wherein the control system is configured to send a signal to notify a user when the fuel filter operating life is below a threshold filter life.

6. The fuel cell system of claim 2, wherein the control system is configured to select an operating mode based on the filter life information.

7. The fuel cell system of claim 6, wherein the control system is configured to discontinue fueling the fuel cell when the filter life is below a threshold filter life.

8. The fuel cell system of claim 1, wherein the replaceable fuel filter member comprises filtering media and wherein the data storage device is configured to store filtering media information thereon.

9. The fuel cell system of claim 8, wherein the filtering media comprises sulfur removal material.

10. The fuel cell system of claim 1, wherein the data storage device is configured to store fuel filter member volume information thereon and wherein the control system is configured to select an operating mode based on the fuel filter volume information.

11. The fuel cell system of claim 10, further comprising one of an ambient temperature measurement device and an ambient pressure measurement device, wherein the data storage device is configured to determine an operating mode based on the filter volume and one of the ambient temperature and the ambient pressure.

12. The fuel cell system of claim 1, comprising a replaceable fuel reservoir having a data storage device configured to store fuel information thereon.

13. The fuel system of claim 5, wherein the control system is configured to
access filter property information from the replaceable filter data storage device, accesses fuel information from the fuel reservoir, and select an operating mode based on both the replaceable filter property information and the fuel information.

14. The fuel cell system of claim 1, wherein the fuel cell system comprises a communications bus and wherein the fuel filter comprises a communications device for communicating with the control system through the communication bus during loop cycles such that the communications device is configured to send information during a first time period of each loop cycle and to receive information during a second time period of each loop cycle.

15. A fuel cell system comprising:
a fuel tank, fuel tank comprising a raw fuel stored therein,
a fuel filter member configured to receive raw fuel from the fuel tank and to refine the raw fuel to a refined fuel, said replaceable filter comprising a filter property indicator;
a fuel cell stack configured to receive refined fuel from the fuel filter and to utilize the refined fuel to generate electricity and
a control system configured to access the filter property indicator of the fuel filter member.

16. The fuel cell system of claim 1, wherein the filter property indicator comprises a microprocessor.

17. The fuel cell system of claim 1, wherein the filter property indicator is a filter life indicator.

18. A method for controlling a fuel cell system, the fuel cell comprising a control system and a replaceable fuel filter member comprising a data storage member having fuel filter property data stored thereon, the method comprising:
accessing the fuel filter information of the data storage member; and
selecting an operating mode of the fuel cell system based on the fuel filter information.

19. The method of claim 18, further comprising:
accessing a first filter life level from the data storage member;
determining a second filter life level based the first filter life level and at least one of a time duration and a fuel flow level; and
writing a second filter life level to the data storage member.

20. The method of claim 19, further comprising:
providing a threshold filter life level;
accessing a third filter life level from the data storage member;
comparing the third filter life level to the threshold filter life level; and
shutting off fueling when the threshold filter life level is lower than the third filter life level.
